(19) United States
(12) Patent Application Publication
(10) Pub. No.: US 2010/0241401 A1
(43) Pub. Date: Sep. 23, 2010

(54) Solar collector electronic freeze protection system, with differential circulation control of pump and automatic freeze protection

(75) Inventor: Wilbur Kenneth Martindale, Malabar, FL (US)

Correspondence Address: W. Kenneth Martindale, 215 Ormond Drive, Indialantic, FL, 32903, US

(73) Assignee: Russell & Sun Solar Corporation, Indialantic, FL (US)

(21) Appl. No.: 12/790,449

(22) Filed: May 28, 2010

Related U.S. Application Data
(60) Provisional application No. 61/314,712, filed on Mar. 17, 2010.

(51) Int. Cl. G06F 15/00; H02J 7/00; G05D 23/00; F28D 15/00

(52) U.S. Cl. 702/182; 307/66; 165/11.1; 165/104.31

(57) ABSTRACT

An automatic and electronic freeze protection system for solar energy collector systems. The system includes a solar collector for collecting solar energy in the form of heat, a circulation pump operated by a DC power source (typically a small photovoltaic module), a storage tank, an ac current connection to provide freeze protection at times when no sun is available, and various valves and piping to complete. Sensors are provided at both the storage tank and the solar collector to monitor the temperature of the water and also the temperature of the collector (more specifically, the temperature of the fluid in the collector). Whenever the fluid in the collector approaches its freeze point, the electronic freeze protection will use AC or battery power to energize the DC circulation pump, thereby circulating water from the storage tank to and through all components of the system. When the temperature of the collector (the temperature of the fluid in the collector) rises to a predetermined point and freezing is no longer imminent or possible, the electronic freeze protection will shut off the circulation pump. This process will repeat as often as is necessary to protect the collector and system components that are exposed to freezing temperatures. The primary difference between our current invention and existing systems is that there is no electronic freeze protection device available for DC-solar systems. In addition, we have combined existing DC differential control with electronic freeze protection for a truly unique and extremely useful improvement. Differential control of the circulation pump will increase efficiency of the system, thereby increasing total solar gain. Finally, and uniquely, this invention includes fault protection in the event of an open or shorted sensor at the collector. In the event of a fault, the present invention will energize the circulation pump, thereby preventing freezing and making the system fail-safe. The invention is unique by three means: combination of electronic freeze protection AND differential control in a single unit, automatic backup with battery and ac power, and fault protection for fail-safe operation.

### BACKGROUND OF THE INVENTION

1. Field of the Invention

The present invention relates generally to the field of solar energy utilization apparatus, and more particularly, to an automatic freeze protection system for use in DC-powered solar energy collector systems.

2. Description of the Prior Art

Heating fluids with solar energy is a very old concept. In recent years, significant improvements have been made in efficiency of collectors, reliability of system components, and reduction in costs. While numerous solar collectors are available for these systems, the primary cost of these collectors is in the materials used in construction (largely dictated by the price of raw materials), and the construction of the collectors themselves.

The present invention solves a problem which is common in warmer weather climates. Specifically, in those areas wherein outside temperatures may drop near or below the freezing point of water, some form of protection must be provided to prevent water from freezing within the collector or within the plumbing leading to and from the collector as its expansion by freezing can obviously cause very severe damage to the entire system. While freeze situations are not common, they occur frequently enough that effective freeze protection measures are required. Additionally, more complex and expensive freeze protection, such as heat exchangers or drain back apparatus, is not usually warranted, arising the need for reliable, inexpensive, long-lasting protection.

The current designs that are prevalent in areas of the country with relatively warm winter climates where the threat of freeze is still significant is to use one of several methods:

Method one is the least expensive and most common for warmer climates: open loop solar water heating systems that employ manual freeze protection and/or automatic freeze protection by way of a dump valve. Typically these systems are powered by a DC (photovoltaic module) pump and therefore have the advantage of (1) having the ability to heat water even when there is no external power supplied to the house, as in the case of power outage, and (2) they consume no power during normal operation, saving even the cost of circulating the water though the system. The primary disadvantage of this type of system is that the freeze protection employed is unreliable, expensive, and not fail-safe; expensive repairs often result when the freeze valve fails. The freeze valve is designed to open when reaching predetermined temperatures to let [warm] water flow from the storage tank, through system components, to the outside, usually onto the roof as waste. An additional disadvantage is that there is some efficiency lost when powering the circulation pump with a PV module. The PV module cannot be mated perfectly for every situation. The resultant mismatch causes the pump to operate at times that are not optimum to meet the goals of the solar system: collect heat from the sun. They may actually operate when the collector temperature is less than the temperature of the storage tank. In these cases, heat will be radiated off the collector, thereby lowering the temperature of the water in the storage tank.

Method two is more expensive: use an AC-powered pump to circulate the heated fluid. This method enjoys the advantage of incorporating freeze protection in the electronic unit that controls the AC pump; it will turn on the pump when the outside temperatures approach freezing. The primary disadvantage is that freeze protection is lost in the event of simultaneous power-failure and cold temperatures. Additionally, there is a perpetual cost to operating an AC-powered pump, thereby reducing the overall savings one seeks when heating water with solar energy. Finally, during extended power outages, including catastrophic weather events such as hurricanes, an AC-powered solar system will not work.

Method three is also undesirable in warmer climates: use a heat exchanger and alcohol-based heat transfer medium to heat water in the storage tank. These closed-loop systems are more complicated and more expensive than simple open-loop systems and require additional maintenance (periodically changing the heat transfer medium). They are much less efficient and replacement tanks are more expensive. There is little demand or need for these systems in warmer climates.

Method four is most expensive: drain back systems that use heat exchangers to transfer the energy in a heated medium to the water in the storage tank. These systems are immune to freezing as there is no fluid to freeze when the system is not operational; it drains back to a small reservoir when the system turns off. The disadvantages of systems of this type are added complexity, they require AC-powered circulation pumps, they are much less efficient, replacement tanks are more expensive, and the initial cost is much higher than simpler open-loop systems. For these reasons, closed-loop drain back systems are not common or practical in warmer climates.

### SUMMARY OF THE PREFERRED EMBODIMENTS

In accordance with the present invention, a solar energy collection system that avoids all of the inadequacies inherent in the prior art is provided. Specifically, in accordance with the present invention, a system is provided that employs a simple and cost-effective open loop system and, hence, dispenses of the need for AC-powered pump, failure-prone valves, inefficient DC pump control, periodic maintenance, and expensive heat exchangers. Instead, with the present invention, only a single water circulating system is required with water circulating from the collector directly into a water tank for storage or utilization. Sensor fault protection has also been incorporated preventing sensor failures from disabling the freeze protection.

In order to prevent the water from freezing up in the collector when the temperature drops near or below the freezing point, an automatic and electronic freeze protection system is provided. Specifically, a temperature sensor is affixed at the coldest part in the collector, and when the temperature within the collector approaches the freezing point of water, the electronic control will automatically turn on the circulation pump, drawing AC-power from the house circuit, in order to circulate warm water from the storage tank and through the affected equipment. The electronic control device will then automatically turn off the circulation pump after several minutes when the temperature of the collector reaches a predetermined temperature well above freezing. This process will repeat as often as is necessary until the threat of freezing has passed. In the event of simultaneous power failure and freezing temperatures, there is a battery back-up rather than AC power to power the circulation pump. Thus, the present invention provides a fully automated system that will permit effective solar energy collection, while at the same time, eliminate maintenance and replacement costs associated with traditional dump valves, improve reliability and safety, avoid the need for anti-freeze and the expense and risks introduced thereby, all with the inherent advantages of a DC-powered solar energy collection system.

A further advantage obtained with the present invention is the incorporation of differential control of the circulation pump as mentioned above. Traditionally, differential control has been the domain of AC-powered systems. The advantage of differential control is that the circulation pump can be regulated electronically and therefore much more efficiently. The resultant gain in energy capture is significant, effective, and useful. Previously, a circulation pump powered directly by a PV module, while very simple and essentially maintenance-free, is impossible to regulate effectively for each installation situation. Most systems will operate at 10-20% reduced efficiency compared to a perfectly mated system in which the pump operates only when sufficient solar energy is available to actually add heat to the water. Currently, it is possible and common that sufficient solar energy is available to operate the circulation pump but not actually add heat to the storage tank. This is particularly true early and late in the heating cycle. The present invention solves this problem and incorporates both effective and fail-safe freeze protection with differential control of circulation in a DC-powered solar energy system.

### BRIEF DESCRIPTION OF THE DRAWINGS

FIG. 1 illustrates, in schematic form, the freeze control system according to a present embodiment of the invention.

### DETAILED DESCRIPTION OF THE PREFERRED EMBODIMENT

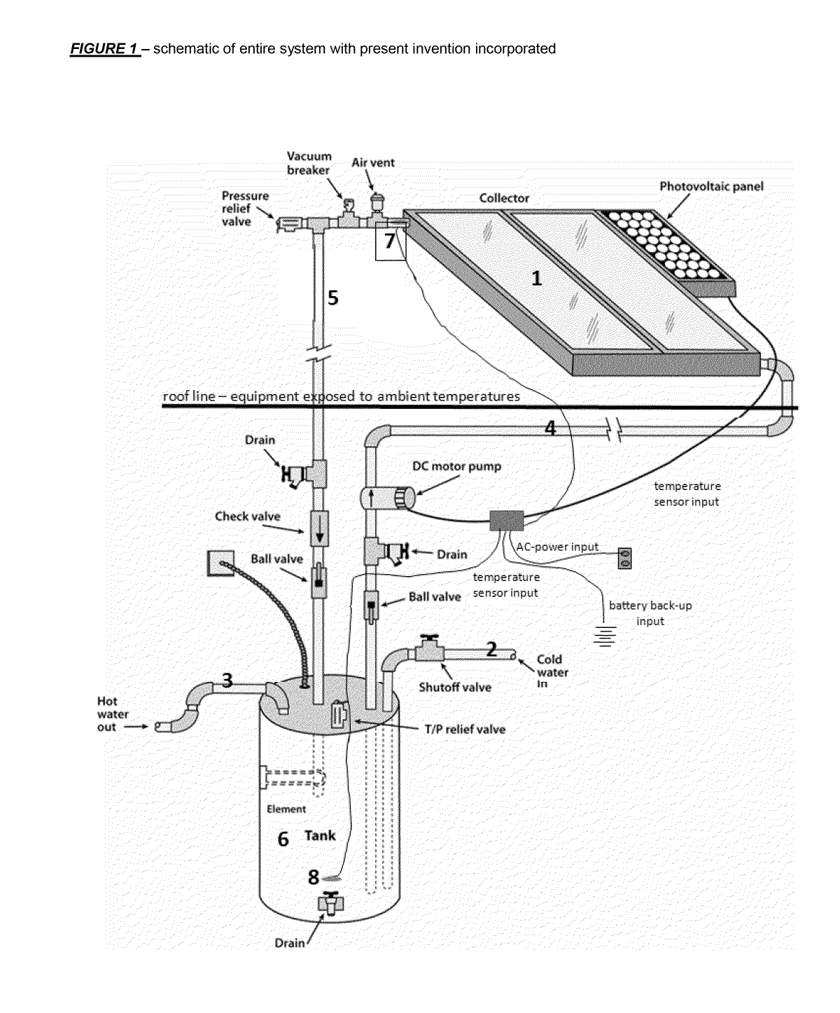

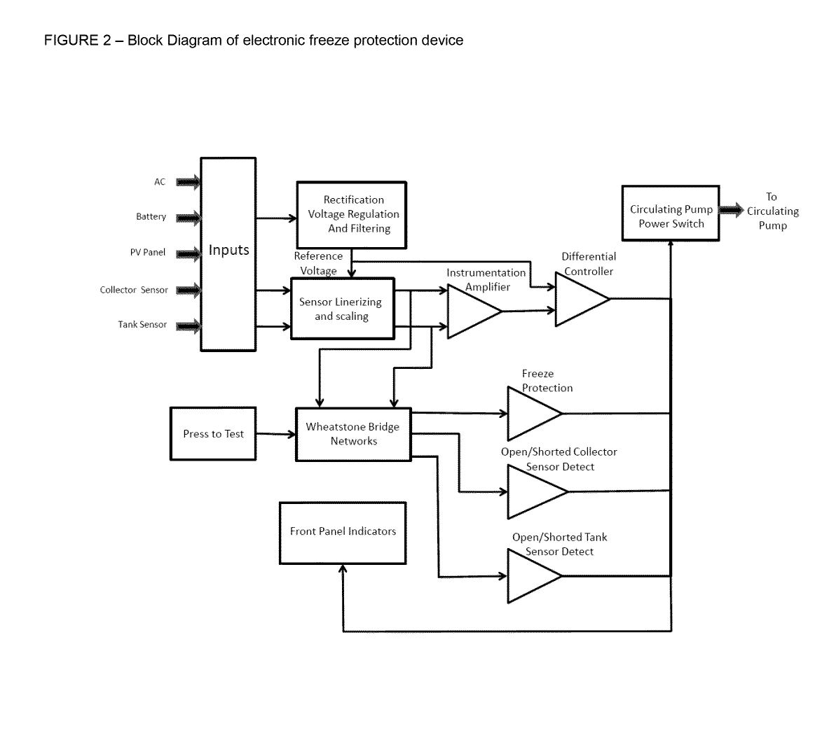

FIG. 1 illustrates, in schematic form, the automatic freeze protection system according to a presently preferred embodiment of the invention. Reference number 1 identifies the solar collector which is mounted outside the house or other building to receive the heating rays of the sun. Its specific construction is not important to the present invention and any one of a number of collector designs may be employed. One suitable collector, however, is Alternate Energy Technology's (AET) AE-40 solar collector. This collector, basically, comprises a network of copper conduits encased in an insulated aluminum frame through which water or other fluid is circulated to be heated by the sun.

The system, as illustrated in FIG. 1, further includes a plumbing system for carrying water to and from the collector as required. Specifically, the system includes a cold water input line 2 for carrying water from a source, not shown, but conveniently from an ordinary city water line, into the solar collector to be heated; and a hot water output line 3 for carrying heated water out of the storage tank 6 for use in the dwelling/business. Lines 4 carries water to the collector for energy absorption and line 5 from the collector to the storage tank 6. In ordinary operation, hot water from the collector will be transferred to the tank 6 through line 5 from line 4 and be replaced by fresh water from line 2 in a conventional manner which need not be discussed in detail herein. As the temperature at the collector approach freezing (42 degrees F.) as read by temperature sensor 7, our present invention will energize the DC motor/pump assembly and circulate warm water (previously solar heated) from storage tank 6, through pipe 4, through collector 1, return to the storage tank 6 through pipe 5. As temperature sensor 7 heats up to the predetermined temperature (60 degrees F.), as interpreted by our present invention, DC power to the circulation pump will be terminated. This process may repeat several times as necessary. In the event of simultaneous power failure and cold temperatures, battery back-up will provide the necessary power to energize the circulation pump to effect the same operation.

The system, as illustrated in FIG. 1, further includes differential control of the DC circulation pump. In normal operation, our present invention will interpret the readings from temperature sensor 8 at the bottom of the storage tank 6 and compare the reading with temperature sensor 7 at the collector. As the heat available at the collector increases in the morning to a point where effective heating can take place, our present invention will energize the circulation pump appropriately. This positive control is preferential to direct PV power insomuch as the circulation pump will not come on prematurely, as is the case in direct sunlight when insufficient solar energy exists to heat water yet sufficient solar energy exists to power the circulation pump. Alternately, it is a common occurrence that the water in the storage tank gets extremely hot throughout a day of solar heating and sufficient solar energy exists to continue powering the pump but insufficient solar energy exists to heat the water above the temperatures obtained during the normal operation, which includes the highest solar intensity periods of the day. In this case, heat gained during the day will radiate heat from the collector and water will be returned from the collector to the tank cooler than when it went to the collector. This undesirable situation is common and can decrease total heat gain by up to 10-20%.

Because anti-freeze or other harmful or potentially harmful materials are not used in the present invention, the heated water in the collector can be directly utilized in any desired manner as discussed above.

FIG. 2 shows a block diagram of the invention. There are three power inputs. The first is the Line or AC input. This is stepped down through a transformer, rectified and filtered to produce a DC voltage. The second input is a battery input at a nominal 12 volts. The last input is the photovoltaic panel power, typically 18-20v dc at 0.5-0.6A. Power for operation comes from these three power inputs. This unique invention can operate from any one power input; AC, battery, or the PV panel.

The other two inputs are the tank sensor and the collector sensor. Sensors can be used that have exponential characteristics through a linearizing network. The collector sensor and the tank sensor produce voltages that are sensed by the Instrumentation amplifier to produce a voltage proportional to the difference between the collector temperature and the tank temperature. This difference is compared by the differential controller such that when the collector temperature is hotter than the tank temperature by a pre-determined difference the circulating pump is turned on heating the tank water to a higher temperature. As the collector cools down, this difference is also sensed and the circulating pump is shut down at a second lower temperature difference. This maximizes the heating capability of the collector.

Freeze protection is provided by sensing the collector temperature and as the collector approaches the freezing point by a predetermined difference the circulating pump is turned on preventing the collector from freezing.

Our invention will detect when either or both sensors are inoperable, either shorted or open. In the event of this shorted or open fault a flashing indicator is turned on along with the circulation pump. This provides a fail-safe system preventing any damage to the solar heating system.

The freeze protection and the fault detection use a Wheatstone Bridge Network for their sensing.

Front panel indicators can be LEDs or an alpha-numeric display. A combination of these displays can also be used.

In summary, the present invention provides a highly efficient solar energy system designed for use in warmer weather climates. The invention provided avoids the need for dump valves, anti-freeze or other materials to prevent water freeze-up, and, in doing so, also eliminates the need for a closed loop water system in the collector as suggested in the prior art, together with heat exchangers to transfer heat from the collector water to the house water, as well as other safety equipment often necessitated by the use of anti-freeze. Because heat exchangers are not needed, greater efficiency is obtainable at reduced expense and complexity.

While what has been described is a presently most preferred embodiment, it should be recognized that the invention may take many other forms and include other slight modifications. These modifications will not affect the value of our present invention as our invention capitalizes on current technologies to gain the most efficiency from the solar energy at the lowest cost (in terms of maintenance, safety to system, and reliability). For example, the system could also incorporate a built-in battery back-up rather than an external back-up. This would not change the operation of our invention. Also, it should be understood that many other types of valves and sensors could be used with the invention if so desired. Finally, if should be emphasized that the invention can be used in a wide variety of applications in addition to domestic hot water systems. For example, it could conveniently be employed in pool heating, space heating and other applications.

Because many additions, omissions and modifications can be made to the present invention, it should be understood that the invention should be limited only insofar as required by the scope of the following claims.

What is claimed is:

1. An electronic freeze protection system for DC-operated solar collectors comprising:
a. solar collector means for holding and circulating a fluid to be heated;
b. circulation of fluid by means of a DC-powered circulation pump rather than AC-powered;
c. temperature sensors to continuously monitor the temperature of the collector and the storage tank;
d. electronic controls that will automatically sense when freeze, and therefore damage to the solar collector, is imminent which will automatically turn on the circulation pump, with auxiliary AC power or back-up battery power in order to circulate the fluid through the components that are in imminent danger of freeze damage.

2. A system as recited in claim 1 and further including electronic controls that most efficiently controls the circulation pump to provide maximum heat gain from the solar collector, thereby increasing efficiency and increasing the life of the circulation pump.

3. A sensor fault detector that will automatically sense an open or shorted collector or storage tank sensor. The fault will operate the circulation continuously and will provide a display indication to alert the user of the system. This will protect the collector from freezing in the event of a collector sensor failure either shorted or open and provides a fail safe function.

4. A press to test function is included to confirm operation of the freeze protection.

5. A battery back up provision is part of the invention. The battery back up provides power for the freeze protection during AC power line failure.
